(19) United States
(12) Patent Application Publication
(10) Pub. No.: US 2004/0260823 A1
(43) Pub. Date: Dec. 23, 2004

(54) Simultaneously transporting multiple MPEG-2 transport streams

(75) Inventors: Ashish Tiwari, San Diego, CA (US); Gregory McDonald, San Diego, CA (US); An Tonthat, San Diego, CA (US); Bridget Diane Kimball, Encinitas, CA (US)

Correspondence Address: LAW OFFICE OF BARRY R LIPSITZ, 755 MAIN STREET, MONROE, CT, 06468, US

(73) Assignee: General Instrument Corporation, Horsham, PA

(21) Appl. No.: 10/464,348

(22) Filed: Jun. 17, 2003

(51) Int. Cl. G06F 15/16

(52) U.S. Cl. 709/230

(57) ABSTRACT

Methods and apparatus are provided for sending multiple MPEG transport streams over an interface, between, e.g., a host set top box (STB) and an endpoint device such as an access control device (ACD). The addition of a multi-byte field consisting of Transport ID (TSID), Packet ID (PKTID), Cyclic Redundancy Check (CRC) bits, Local Time Stamp etc. to an MPEG-2 transport stream makes possible simultaneous transfer of multiple transport streams through high speed isochronous transfers using only one transmit and one receive pipe. Use of only one transmit and one receive pipe causes less CPU loading and offers better bandwidth utilization by causing much less overhead on the bus compared to using multiple transmit and receive pipes.

### TECHNICAL FIELD

The present invention relates to video signal processing, and more particularly to processing multiple digital video signal streams or the like.

### BACKGROUND ART

Recent advances in cable and satellite distribution of subscription and “on-demand” audio, video and other content to subscribers have given rise to a growing number of digital set-top boxes (STBs, sometimes referred to as Digital Consumer Terminals or “DCTs”) for decoding and delivering digitally broadcast programming. These set-top boxes often include additional circuitry to make them compatible with older analog encoding schemes for audio/video distribution. As the market for digital multimedia content of this type grows and matures, there is a corresponding growth of demand for new, more advanced features.

Video-on-demand (VOD) and audio-on-demand are examples of features made practical by broadband digital broadcasting via cable and satellite. Unlike earlier services where subscribers were granted access only to scheduled encrypted broadcasts (e.g., movie channels, special events programming, etc.), these on-demand services permit a subscriber to request a desired video, audio or other program at any time. Upon receiving the request for programming (and, presumably, authorization to bill the subscriber's account), the service provider then transmits the request program to the subscriber's set-top box for viewing/listening. The program material is typically “streamed” to the subscriber in MPEG format for immediate viewing/listening, but can also be stored or buffered in the set-top box (typically on a hard-disk drive or “HDD”) for subsequent viewing/listening.

Digital video broadcasts are typically transmitted (via cable or satellite) using a digital video compression scheme for encoding. Video compression is a technique for encoding a video “stream” or “bitstream” into a different encoded form (preferably a more compact form) than its original representation. A video “stream” is an electronic representation of a moving picture image.

The Motion Picture Association of America (MPAA) is a trade association of the American film industry, whose members include the industry's largest content providers (i.e., movie producers, studios.) The MPAA requires protection of video-on-demand (VOD) content from piracy. Without security to protect content against unauthorized access, MPAA member content providers will not release their content (e.g., movies) for VOD distribution. Without up-to-date, high-quality content, the VOD market would become non-viable.

Encryption methods are continually evolving to keep pace with the challenges of video-on-demand (VOD) and other consumer-driven interactive services. With VOD, headend-based sessions are necessarily becoming more personalized. In this scenario, video streams are individually encrypted and have their own set of unique keys.

One of the best known and most widely used video compression standards for encoding moving picture images (video) and associated audio is the MPEG-2 standard, provided by the Moving Picture Experts Group (MPEG), a working group of the ISO/IEC (International Organization for Standardization/International Engineering Consortium) in charge of the development of international standards for compression, decompression, processing, and coded representation of moving pictures, audio and their combination. The ISO has offices at 1 rue de Varembé, Case postale 56, CH-1211 Geneva 20, Switzerland. The IEC has offices at 549 West Randolph Street, Suite 600, Chicago, Ill. 60661-2208 USA.

The international standard ISO/IEC 13818-2 “Generic Coding of Moving Pictures and Associated Audio Information: Video”, and ATSC document A/54 “Guide to the Use of the ATSC Digital Television Standard” describes the MPEG-2 encoding scheme for encoding and decoding digital video (and audio) data. The MPEG-2 standard allows for the encoding of video over a wide range of resolutions, including higher resolutions commonly known as HDTV (high definition TV.)

The MPEG-2 standard specifies formatting for the various component parts of a multimedia program. Such a program might include, for example, MPEG-2 compressed video, compressed audio, control data and/or user data. The standard also defines how these component parts are combined into a single synchronous bit stream. The process of combining the components into a single stream is known as multiplexing. The multiplexed stream may be transmitted over any of a variety of links, such as Radio Frequency Links (UHF/VHF), Digital Broadcast Satellite Links, Cable TV Networks, Standard Terrestrial Communication Links, Microwave Line of Sight (LoS) Links (wireless), Digital Subscriber Links (ADSL family), Packet/Cell Links (ATM, IP, IPv6, Ethernet.)

A fundamental component of any MPEG bit stream is an elementary stream (ES.) A “program” comprises a plurality of ESs. Each ES is provided as an input to an MPEG-2 processor (e.g. a video compressor) which formats the ES into a series of Packetized Elementary Stream (PES) packets.

The MPEG-2 standard defines two forms of multiplexing (combining of ESs into a single stream):

MPEG Program Stream. A group of tightly coupled PES packets referenced to a common time base. Such streams are suited for transmission in a relatively error-free environment and enable easy software processing of the received data. This form of multiplexing is used for video playback and for some network applications.

MPEG Transport Stream. Each PES packet is broken into fixed-sized transport packets, providing the basis of a general-purpose technique for combining one or more streams, possibly with independent time bases. This is suited for transmission in which there may be potential packet loss or corruption by noise, and/or where there is a need to send more than one program at a time.

The Program Stream is widely used in digital video storage devices, and also where the video is reliably transmitted over a network (e.g. video-clip download.) Digital Video Broadcast (DVB) uses the MPEG-2 Transport Stream (TS) over a wide variety of underlying networks. Since both the Program Stream and Transport Stream multiplex a set of Packetized Elementary Stream (PES) inputs, interoperability between the two formats may be achieved at the PES level. The discussion herein is directed mainly to processing the MPEG Transport Stream (TS.)

The MPEG transport stream consists of a sequence of fixed sized transport packets of 188 bytes. Each packet comprises 184 bytes of payload and a 4 byte header. One of the items in this 4 byte header is the 13 bit Packet Identifier (PID) which plays a key role in the operation of the Transport Stream.

Various elementary streams can be sent in the same MPEG-2 transport stream (e.g., two elementary streams containing video and audio packets, respectively.) Each packet is tagged with a PID value that identifies it as being associated with a specific PES. Typically, audio packets are tagged with a unique PID and video packets are tagged with a different PID. The actual PID values are arbitrary, but they necessarily have different values. Usually there are many more video packets than audio packets, so the two types of packets are usually not evenly spaced in time.

Multiple Program Streams

An outgrowth of digital set-top box (DCT) technology is set-top boxes (STBs) with embedded PVRs/DVRs (Personal Video Recorder/Digital Video Recorder), whereby video content can be recorded directly to a storage device (e.g., hard disk or local memory) for subsequent playback. As with conventional video recording applications (e.g., video cassette recorders—VCRs), it is often desirable to record one program “stream” while viewing another—an application that operates on two video streams simultaneously.

Another common application of modern set-top boxes, televisions, etc., is Picture-In-Picture (PIP), where an inset (thumbnail) display of a first video stream is overlaid on a full-screen display of a second video stream. Like simultaneous viewing and recording, PIP operates on two video streams simultaneously.

Historically, for analog television broadcasts, these dual-stream applications required “dual tuner” functionality—one tuner for receiving the program to be viewed, the other to receive the program to be recorded. Since most VCRs include an independent tuner for recording and a broadband pass-through capability, the “dual tuner” requirement is effectively satisfied. To provide the same capability, embedded DVR and PIP applications (when built into a single unit) must provide for the ability to decode at least two digital video streams simultaneously, either or both of which may be encrypted.

Generally, encryption of an MPEG-2 transport stream involves encryption of the data content of a transport stream, but not the structure thereof. That is, only the data payload portion of transport packets in a transport stream is encrypted, but the structure of the transport packets themselves (header, flags, framing, etc.) is sent in the clear (unencrypted.) Encrypted and non-encrypted stream data can be mixed in a transport stream.

The encryption method used to encrypt a particular PES is identified in the PES header. Once it has been determined that a PES contains an encrypted payload (e.g., encrypted video or audio), then all transport packets with PIDs associated with that PES must be routed through a decryption mechanism prior to decoding. Typically, this decryption mechanism is a dedicated encryption engine, e.g., an integrated circuit (IC) chip or dedicated hardware specifically designed to perform the decryption function. One example of a chip with this type of decryption capability is Motorola's MC 1.7 (MediaCipher v1.7) Conditional Access Control chip.

A security or access control device provides for security in digital set-tops (STBs.) The STB has a receptacle slot for the access control device (ACD) which contains signal decryption and conditional access elements. Although described in connection with an STB and an access control device, it should be appreciated that many other host and client systems can be deployed in accordance with the invention.

Asynchronous, Synchronous, Isochronous Communication

As its name implies, asynchronous communication is performed between two (or more) devices which operate on independent clocks. Therefore, even if the two clocks agree for a time, there is no guarantee that they will continue to agree over extended periods, and thus there is no guarantee that when Point A begins transmitting, Point B will begin receiving, or that Point B will continue to sample at the rate Point A transmits. To combat this timing problem, asynchronous communication requires additional bits to be added around actual data in order to maintain signal integrity. Asynchronously transmitted data is preceded with a start bit which indicates to the receiver that a word (a chunk of data broken up into individual bits) is about to begin. To avoid confusion with other bits, the start bit is twice the size of any other bit in the transmission. The end of a word is followed by a stop bit, which tells the receiver that the word has come to an end, that it should begin looking for the next start bit, and that any bits it receives before getting the start bit should be ignored. To ensure data integrity, a parity bit is often added between the last bit of data and the stop bit. The parity bit is used to assure that the data received is composed of the same number of bits in the same order in which they were sent. Asynchronous communication requires nothing more than a transmitter, a receiver and a wire. It is the simplest of serial communication protocols, and the least expensive to implement.

As its name implies, synchronous communication takes place between a transmitter and a receiver operating on synchronized clocks. In a synchronous system, the communication partners have a short conversation before data exchange begins. In this conversation, they align their clocks and agree upon the parameters of the data transfer, including the time interval between bits of data. Any data that falls outside these parameters will be assumed to be either in error or to be a placeholder used to maintain synchronization. (Synchronous lines must remain constantly active in order to maintain synchronization; thus the need for placeholders between valid data.) Once each side knows what to expect of the other, and knows how to indicate to the other whether what was expected was received, then communication of any length can commence.

The theory behind asynchronous and synchronous communication is essentially the same: Point B needs to know when a transmission from Point A begins, when it ends, and if it was processed correctly. However, the difference lies in how the transmission is broken down.

Unlike asynchronous and synchronous communication, which both involve elaborate error checking mechanisms, the driving force behind isochronous communication is a fast, steady, uninterrupted data stream. Isochronous clocking information is derived from or included in the data stream, and the delay factor is dependent on a channel's characteristics and can be logically determined. Communication can be disrupted if the transmitter does not maintain a constant transfer rate, or if the receiver has an insufficient buffer to store data at the rate it is arriving and then hold it until it can be processed by software. To maintain data transfer speed, error checking is often omitted. Though software can be written to track errors, there is no hardware mechanism by which to request retransmission of corrupted data.

Isochronous communication is best suited for applications where a steady data stream is more important than accuracy. A good example is video conferencing where infrequent small “blips” in the data stream are tolerable, but long pauses between a transmission and a response are not. To ensure that isochronous transfers are not bogged down by other devices, the Universal Serial Bus (USB) specification sets aside bandwidth for them. IEEE 1394 (FireWire) also uses isochronous communication, as it is ideal for the high-speed video and audio applications for which the bus was designed.

Universal Serial Bus (USB)

Universal Serial Bus (USB) is bidirectional, isochronous, dynamically attachable serial interface which is commonly used for adding peripheral devices such as game controllers, serial and parallel ports, and input devices on a single bus. The connectivity specification for USB was developed by the USB Implementers Forum. USB is aimed at peripherals connecting outside the computer in order to eliminate the need for opening the computer case for installing cards needed for certain devices. USB ecompasses both interface and method of communication. To maintain data transfer speed, error checking is often omitted. Up to 127 devices can be connected to a USB bus via a single hub. Client software communicates directly with its device. Each device has a unique address, which is assigned to it by the USB system software during configuration to avoid conflicts.

Communication between devices and client software is conceptualized as using pipes. Each pipe is a communication channel between software on the host and an endpoint (e.g., client) on a device. Each endpoint represents a part of a device that fulfils one specific purpose for that device, such as to receive commands or transmit data. A full speed device can have up to sixteen endpoints, though low speed devices can have only three.

Once the endpoints of a device have been identified and configured, pipes come into existence allowing the client software to communicate with the device. A pipe has associated with it characteristics such as a claim on bus access and bandwidth, the type of transfer, the direction of transfer and the maximum data payload size.

The USB standard supports three different modes of operation:

Low Speed Mode: 1.5 Mbps

Full Speed Mode: 12 Mbps

High Speed Mode: 480 Mbps

The USB standard requires that transactions on the bus be divided into 1 ms (millisecond) quanta called “frames” for either a low speed or a full speed transaction, and into 125 μs (microsecond) quanta called “micro-frames” for a high speed transaction. Each micro-frame can contain several transactions. These key USB bus characteristics are summarized in the table below.

Key USB Bus Characteristics

| | Max BW | Frame | Max Bytes/ |
|---|---|---|---|
| Bus Speed | (Mbps) | Time | Frame |
| Low | 1.5 | 1 ms | 187 |
| Full | 12 | 1 ms | 1500 |
| High | 480 | 125 μs | 7500 |

USB Transfer Types

The USB standard defines four types of transfer:

control transfers: bursty, non-periodic, host software initiated request/response communications, typically used for command or status operations,

interrupt transfers: low-frequency, bounded-latency communications which are initiated by a device to request some action from the host,

isochronous transfers: periodic, continuous communication between host and device, typically used for the delivery of time-relevant information, such as for video and speech. These transfers are high speed or full speed only. (Low speed isochronous transfers are not allowed.) USB requires that periodic transfers (interrupt and isochronous) should not occupy more than 90% of a frame for full speed endpoints and 80% of a micro-frame (6000 bytes) for high-speed endpoints.

bulk transfers: non-periodic, large packet, bursty communication, typically used for data that can use any available bandwidth, but which is not time critical, and which can be delayed until bandwidth is available. All transfers take the form of packets, which contain control information, data and error checking fields.

In the USB standard, there are also two types of pipe: message pipes and stream pipes. Control transfers are made using message pipes. In a message pipe, the data portion of each packet has some meaning to the USB system software. Stream pipes are used for interrupt, isochronous and bulk transfers. In a stream pipe, the data portion of the packet has no defined meaning to the USB; the data is merely conveyed between client software and device.

USB Bus Overhead

There are several USB attributes that reduce the actual number of bytes that can be used by devices during a frame. These attributes are manifest as overhead (OH) of the bus when viewed from the desired throughput requirements of the device. Specific sources of overhead include packet organization, start of frame (SOF), end of frame (EOF), clock adjustment, time consumed in polling hubs, and time reserved for control transfers.

The USB also uses a feature called bit-stuffing to ensure the presence of sufficient signal transitions for clock recovery. USB bit stuffing consists of inserting an additional 0 bit in the physical bit stream on the bus after six consecutive 1 bits. Therefore, bit stuffing can consume up to 16.67% additional bus time to move a given amount of data. For a random bit-stream, 0.8% bit stuffing is typical.

The estimated transaction protocol overhead (excluding bit stuffing) for different USB transfer types is summarized in the table below. These numbers are simply the bytes/frame equivalents of the nanosecond times reported in section 5.11.3 of the USB 2.0 specification.

Estimated Transaction Protocol Overhead

| | Transaction | Overhead (Bytes/Frame) |
|---|---|---|
| INPUT | High Speed Isochronous | 38 |
| | High Speed Non-Isochronous | 55 |
| | Full Speed Isochronous | 11 |
| | Full Speed Non-Isochronous | 14 |
| | Low Speed Non-Isochronous | 100 |
| OUTPUT | High Speed Isochronous | 38 |
| | High Speed Non-Isochronous | 55 |
| | Full Speed Isochronous | 9 |
| | Full Speed Non-Isochronous | 14 |
| | Low Speed Non-Isochronous | 100 |

Isochronous Endpoint Overhead Calculation

Each USB isochronous transaction has a token phase and a data phase. In the token phase, the host sends an IN/OUT token packet with the device address and endpoint number. The device and endpoint with a match responds with a data Tx/Rx. Thus, the token phase is immediately followed by the data phase. Isochronous transactions do not have a handshake phase or retry capability.

FIG. 1 (upper and lower) illustrates the USB 2.0 transfer format. As shown in FIG. 1 (upper), for data transfers from the endpoint to the host, the transfer starts with a token packet (IN TOKEN PACKET) which comprises 32 sync (SYNC) bits, followed by eight packet identifier (PID) bits, followed by seven address (ADDR) bits, followed by four end packet (ENDP) bits, followed by a five bit cyclic redundancy check (CRC.) The IN TOKEN PACKET is followed by eight bits signifying end of packet (EOP.) Then, before a data packet is sent, an interpacket delay (Δ) of 88 bits is imposed. The DATA PACKET comprises 32 SYNC bits, followed by eight packet identifier (PID) bits, followed by a payload of up to 8192 bits, followed by a sixteen bit cyclic redundancy check (CRC.) After the data packet is transmitted another eight bit EOP and 88 bit delay are imposed, before the next frame.

As shown in FIG. 1 (lower), for data transfers from the host to the endpoint, the transfer starts with an out token packet (OUT TOKEN PACKET), followed by eight bits signifying end of packet (EOP), followed by an interpacket delay (Δ) of 88 bits.

The total overhead (OH), excluding bit-stuffing and host delay for a high-speed isochronous transfer, can be calculated as below:

Isochronous OH=Σ(Token_{—}Pkt_{—}Overhead, 2*EOP, 2*Δ, Data_{—}Pkt_{—}Overhead)=38 Bytes

where

Token_Pkt_Overhead=(SYNC, PID, ADDR, ENDP, CRC5)=7 Bytes,

Data_Pkt_Overhead =Σ(SYNC, PID, CRC16)=7 Bytes,

2*EOP=2*1 Byte=2 Bytes, and

2*Δ=2*11 Bytes=22 Bytes.

High Speed—High BW Isochronous Endpoint Overhead Calculation:

The USB 2.0 specification defines a high-speed isochronous endpoint as a high-bandwidth endpoint when it requires more that 1024 Bytes transferred per micro-frame. A high-speed high-bandwidth endpoint can move up to 3072 Bytes per micro-frame. The specification also limits the maximum data payload size to 1024 Bytes per transaction for each high-speed high-bandwidth endpoint. Consequently, a data payload between 1024 Bytes and 2048 Bytes would require two isochronous transactions and a data payload between 2048 Bytes and 3072 Bytes would require three isochronous transactions.

A multi-packet transaction still follows the rules of the host issuing a separate IN or OUT token for each data phase, and then the device responding. Hence, for a two data packet isochronous transaction, the overhead would be 2*38 Bytes=76 Bytes and for a three data packet isochronous transaction, the overhead would be 3*38 Bytes=114 Bytes. (It should be noted that the bandwidth calculation Table 5-5 in the USB2.0 specification differs in that it only counts 38 bytes for the entire 3072 Byte transfer, when it should be 3×38=1 14 Bytes of overhead. Thus, the ‘Bytes Remaining’ entry in Table 5-5 corresponding to Data Payload of 3072 Bytes should read 1128 Bytes instead of 1280 Bytes.)

FIG. 2 (upper and lower) illustrates the format of a high speed, high BW, isochronous multi-packet transfer. As shown in FIG. 2 (upper), for data transfers from the host (Tx) to the receiver (Rx) endpoint, the transfer comprises out token packets (OUT TOKEN PACKET), followed by EOP, followed by interpacket delay (Δ), followed by a data packet (MDATA, MDATA, DATA0), repeatedly. OUT TOKEN is a packet sent by the host to specify which client should transmit a DATA packet. a DATA packet immediately follows a TOKEN packet. OUT specifies the direction of the data transfer to be from the Host to the Client. In the USB standard, there are two types of data packets, each capable of transmitting up to 1024 bytes of data. These are DATA0 and DATA1. High Speed mode defines another two data types, referred to as DATA2 and MDATA (“MetaData”). MDATA is a data packet with binary PID 1111. This PID is reserved for high-speed high-bandwidth isochronous transactions in a micro-frame. DATA2 is a data packet with binary PID 0111, which PID is also reserved for high-speed high-bandwidth isochronous transactions in a micro-frame. DATA0 and DATA1 are data packets with binary PID 0011 and 1011, respectively. As shown in FIG. 2 (lower), for data transfers from the Rx endpoint to the host (Tx), the transfer comprises in token packets (IN TOKEN PACKET), followed by EOP, followed by interpacket delay (Δ), followed by a data packet (DATA2, DATA1, DATA0), repeatedly.

IEEE 1394 (“FireWire”)

Another high-speed serial communications interface for data transfer is defined under IEEE 1394. The 1394 cable standard defines three signaling rates: 98.304, 196.608, and 393.216 Mbps. (These rates are usually rounded to 100, 200, and 400 Mbps.) The 1394 protocol is implemented by the three stacked layers, performing the following functions:

The transaction layer implements the request-response protocol required to conform to the ISO/IEC 13213:1994 [ANSI/IEEE Std 1212, 1994 Edition] standard Control and Status Register (CSR) Architecture for Microcomputer Buses (read, write and lock.) Conformance to ISO/IEC 13213:1994 minimizes the amount of circuitry required by 1394 ICs to interconnect with standard parallel buses.

The link layer supplies an acknowledged datagram to the transaction layer. (A data gram is a one-way data transfer with request confirmation.) The link layer handles all packet transmission and reception responsibilities, plus the provision of cycle control for isochronous channels.

The physical layer provides the initialization and arbitration services necessary to assure that only one node at a time is sending data and to translate the serial bus data stream and signal levels to those required by the link layer.

Tunneling

“Tunneling” refers to the practice of putting one packet within another. For example virtual private networks (VPNs) use strategy called “tunneling” wherein data packets are first encrypted for security, and then encapsulated in an Internet protocol (IP) package by the VPN and tunneled through the Internet. There are various tunneling protocols. One example is Microsoft's point-to-point tunneling protocol (PPTP) which is an extension of its point-to-point protocol (PPP) and which is included as part of the remote access features on many versions of the Windows® operating system.

### GLOSSARY

Unless otherwise noted, or as may be evident from the context of their usage, any terms, abbreviations, acronyms or scientific symbols and notations used herein are to be given their ordinary meaning in the technical discipline to which the invention most nearly pertains. The following terms, abbreviations and acronyms may be used in the description contained herein:

ACD Access Control Device

ASIC Application-specific integrated circuit

BW Bandwidth

CPU Central processing unit (microprocessor)

CRC Cyclic Redundancy Check

DS Downstream

DVB Digital Video Broadcasting Project

DVR Digital Video Recorder. A high capacity hard drive that is embedded in a set-top box (STB), which records video programming from a television set. DVRs are operated by personal video recording (PVR) software, which enables the viewer to pause, fast forward, and manage various other functions and special applications.

FIFO First-In, First-Out Memory Block

FPGA Field-programmable gate array

HDTV High Definition Television

IC Integrated Circuit (chip)

IEEE 1394 A high-speed serial communications interface commonly referred to as “FireWire”

LTS Local Time Stamp

Mbps Mega (million) bits per second

MPEG Motion Picture Experts Group, a standards organization dedicated primarily to digital motion picture encoding.

MPEG-2 An encoding standard for digital television (officially designated as ISO/IEC 13818, in 9 parts)

OH Overhead

OOB Out of band

PACKET A quantum unit of network data. A packet's contents are generally a header portion (with content and routing information) and a data portion (with the actual data.)

PES Packetized Elementary Stream: In MPEG-2, after the media stream has been digitized and compressed, it is formatted into packets before it is multiplexed into either a Program Stream or Transport Stream

PID Also PKTID. Packet ID (Identifier Code)

PIPE A communication channel between software on a host and an endpoint on a device.

PPTP Point-to-point tunneling protocol

PVR Personal Video Recording. Software and data services combination that allows viewers to interactively select programming choices from an electronic programming guide (EPG) they want to watch or record on their digital video recorder (DVR). Data services are provided, e.g., on a daily basis from the PVR provider.

Rx Receive or receiver

SDTV Standard Definition Television

Set-Top “Set-top box” (STB). An electronic device that allows a television (TV) set to connect to the Internet, game systems or cable systems.

STB Set Top Box

TS Transport Stream. An MPEG transport stream consists of a sequence of fixed sized transport packets of 188 bytes. Each packet comprises 184 bytes of payload and a four byte header.

TSID Transport Stream ID

TV Television

Tx Transmit

US Upstream

USB Universal Serial Bus

VOD Video-On-Demand. The service of providing content through subscriber selection off a large menu of options, available to a viewer at any time.

### SUMMARY OF THE INVENTION

According to the invention, methods and apparatus are provided for sending multiple MPEG transport streams over an interface between a host, such as a set top box (STB) and an endpoint device, such as a removable security module or an access control device (ACD). The transport packets of the MPEG transport streams are modified by adding the following fields to each of the MPEG transport packets:

a transport stream ID (TSID) field for uniquely identifying each of the MPEG transport packets as belonging to a particular one of the multiple transport streams;

a local time stamp (LTS) for tagging the MPEG transport packets with a local time stamp; and

a packet count (PKTcnt) field for marking the MPEG transport packets with an indication of the order in which the packet is stored by the host in a DRAM buffer, and for use as a continuity counter to keep track of all the packets that get transferred.

Optimally, the following fields are also added to each of the MPEG transport packets:

an ACD Reserve bits (ACDres) field which is reserved for use by the ACD.

a host reserve bits (HOSTres) field which is reserved for use by the host; and

a CRC bits field for ensuring that the fields which are added to the MPEG transport packets are transferred correctly across the interface.

It is noted that although in the illustrated embodiment the endpoint device (“client”) is an ACD, other types of client devices can be used in accordance with the invention. Thus, the generic term CLIENTres field is sometimes used herein instead of the more specific term ACD res field.

According to a feature of the invention, at the host a plurality of encrypted transport streams is multiplexed into a first multiplexed stream. The first multiplexed stream is sent to the endpoint device for decryption. At the endpoint device, the first multiplexed encrypted stream is demultiplexed and decrypted. The resulting plurality of demultiplexed, decrypted transport streams is multiplexed and sent back to the host.

The addition of a multi-byte field consisting of Transport ID (TSID), Packet ID (PKTID), Cyclic Redundancy Check (CRC) bits, Local Time Stamp etc. to an MPEG-2 transport stream makes possible simultaneous transfer of multiple transport streams through USB 2.0 high speed isochronous transfers, using only one transmit and one receive pipe. Use of only one transmit and one receive pipe causes less CPU loading and offers better USB 2.0 bandwidth utilization by providing much less overhead on the bus compared to using multiple transmit and receive pipes.

The invention can be used, e.g., in multifunctional high-end cable set-top box hosts with SDTV, HDTV, PVR capabilities, Internet access, etc. The invention can also be used, for example, in removable security modules or decryption devices.

### BRIEF DESCRIPTION OF THE DRAWINGS

FIG. 1 is a diagram of the format of a USB 2.0 isochronous transfer, according to the prior art;

FIG. 2 is a diagram of the format of a high speed, high bandwidth, isochronous multi-packet transfer, according to the prior art;

FIG. 3a is a block diagram of a specific example implementation of the invention deployed in connection with an access control device (ACD) and a set top box (STB), and FIG. 3b is a block diagram of a general embodiment of the invention;

FIG. 4 is a block a diagram of a single endpoint approach to transferring data between an ACD and an STB, according to the invention; and

FIG. 5 is a diagram of transport stream syntax for the single endpoint approach of FIG. 4, according to the invention; and

FIG. 6 is a block a diagram of a multiple endpoint approach to transferring data between an ACD and an STB.

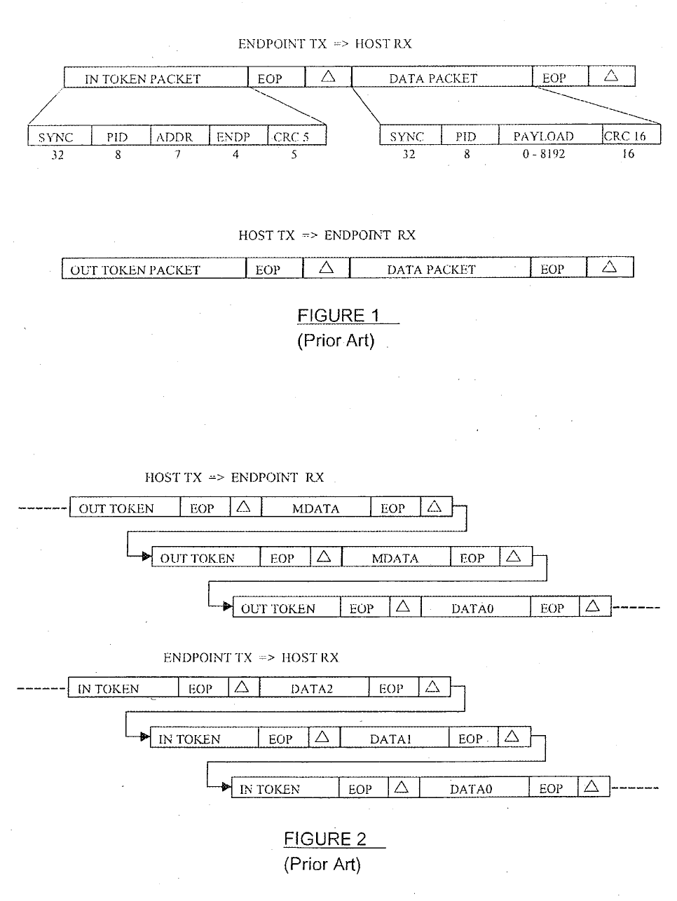

### DETAILED DESCRIPTION OF THE INVENTION

The invention is generally directed to techniques for transferring multiple MPEG transport streams over a high speed serial communications interface. The USB 2.0 standard is used herein as a specific example of such a high speed serial communications interface. It should be appreciated, however, that the invention is not limited to any particular standard, and is generally applicable to any other high speed serial communications interface.

An exemplary application of the invention is to provide for simultaneous decryption of multiple MPEG-2 transport streams (TSs) when an access control device (ACD), which contains signal decryption and conditional access elements, is interfaced (e.g., using USB 2.0) to a host cable set top box (STB). The techniques can be customized according to the requirements of different host set-top boxes and removable security modules. Although explained herein in connection with access control concepts, it should be appreciated that the invention is applicable to any end use where transport streams or the like are merged. Thus, the implementations described herein are provided for example only, and are not intended to limit the scope of the invention or the appended claims.

Access Control Device (ACD)

In the example that follows, an STB (“host”) is capable of outputting two MPEG-2 transport streams, both of which may be encrypted, and a removable security module is capable of providing decryption of services on multiple transport streams (TSs)

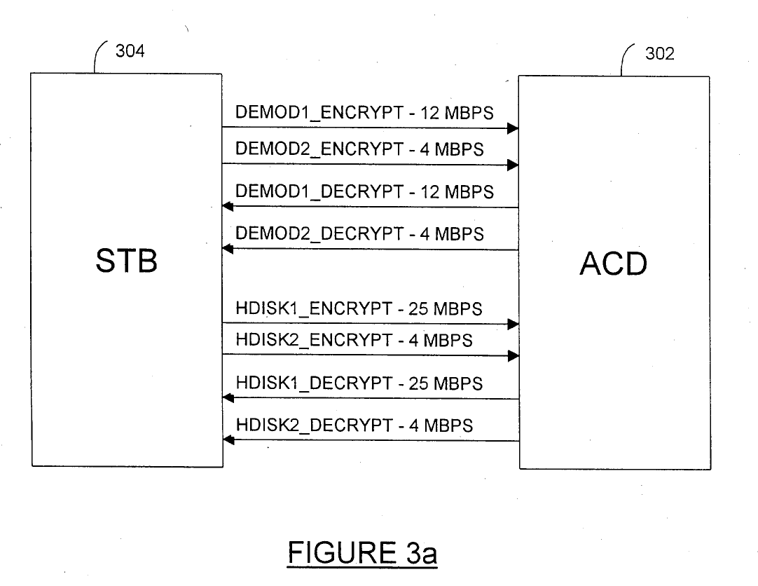

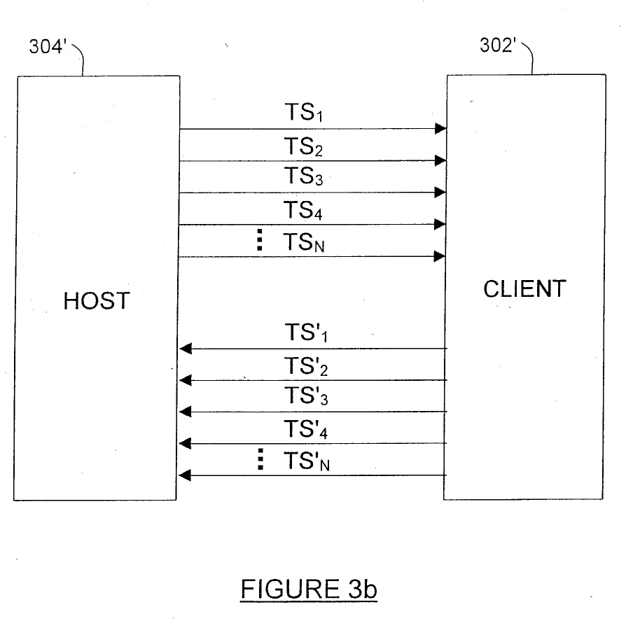

FIG. 3a is a specific, example embodiment illustrating an ACD 302 and a host STB 304, a number of signals passing between the two, and exemplary bandwidth/throughput requirements. A general embodiment is shown in FIG. 3b, wherein a method is provided for multiplexing multiple transport (e.g., MPEG2) streams in a USB isochronous packet and transmitting them from a host to a client. These transport streams can belong to transport multiplexes. The streams TS₁, TS₂, . . . TS_{N} are communicated from the host to the client for processing. The streams TS′₁, TS′₂, . . . TS′_{N} are communicated from the client to the host after processing.

The specific implementation illustrated in FIG. 3a relates to a PVR capable host STB. This is exemplary of an application and requirements being addressed by the present invention. For example, the STB passes two transport streams, Demod1_Encrypt and Demod2_Encrypt, to the ACD for decryption, having bandwidths of 12 Mbps and 4 Mbps, respectively.

Connecting the ACD to the STB Using a High Speed Serial Communications Interface

According to the invention, a high speed serial communications interface is used to connect an endpoint device, such as the ACD 302, with a host, such as an STB 304.

The USB bus transports data through a pipe between a memory buffer associated with a software client on the bus and an endpoint on the USB device. As mentioned above, each pipe is a communication channel between software on the host and an endpoint on a device. Each endpoint represents a part of a device that fulfils one specific purpose for that device, such as to receive commands or transmit data.

Two approaches are disclosed for transferring data across the USB 2.0 interface between the ACD and the host STB:

(1) Single Tx/Rx Endpoint, and

(2) Multiple Tx/Rx Endpoints.

(1) Single Tx/Rx Endpoint

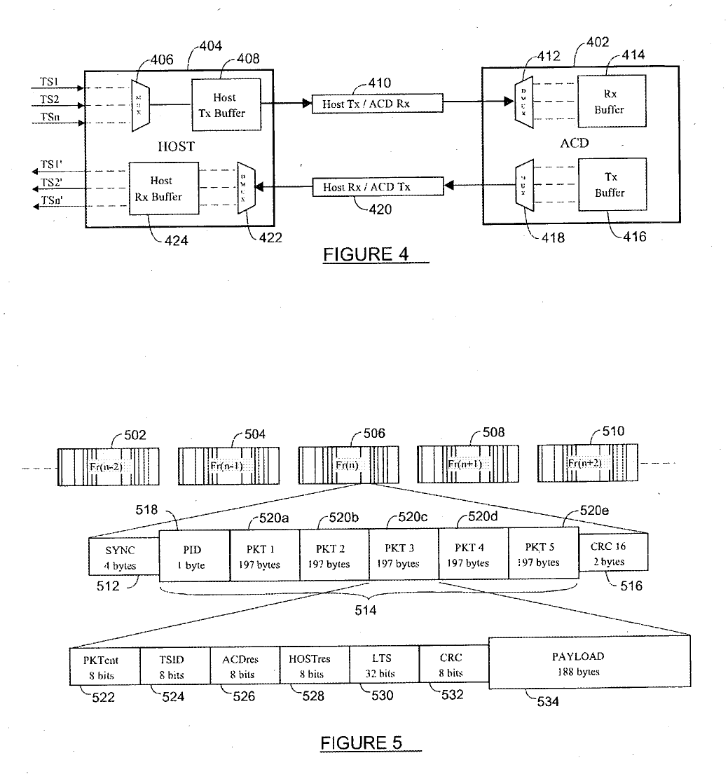

FIG. 4 is a diagram of a single endpoint approach to transferring data between an ACD and an STB, according to the invention.

In a first approach, a single transmit/receive (Tx/Rx) Endpoint is used between an ACD 402 and a host 404 to transfer data belonging to multiple services. This method requires that packets belonging to multiple services be grouped and sent (transported) in a single isochronous packet. This is achieved by the addition of a multi-byte field to the MPEG-2 TS packets, as described in greater detail hereinbelow with respect to FIG. 5.

At the host 404, multiple, encrypted transport streams TS1, TS2 . . . TSn are received and are multiplexed, by a multiplexer 406. A resulting multiplexed stream is buffered by a host Tx buffer 408, and transmitted over a pipe 410 (Host Tx/ACD Rx). At the ACD 402, the multiplexed encrypted stream is demultiplexed by demultiplexer 412 and buffered by an ACD Rx buffer 414. The demultiplexed transport streams are decrypted in the ACD 402, using any suitable decryption technique. The decrypted streams are buffered by an ACD Tx buffer 416 and are multiplexed by a multiplexer 418 for transmission over a pipe 420 (Host Rx/ACD Tx.) At the host 404, the resulting multiplexed decrypted stream is received and is demultiplexed by demultiplexer 422, buffered by a host Rx buffer 424, and output as multiple, encrypted transport streams TS1′, TS2′ . . . TSn′.

Transport Stream Syntax for Single Endpoint Approach

FIG. 5 is a diagram illustrating the transport stream syntax for the Single Tx/Rx Endpoint approach described with respect to FIG. 4.

The USB standard limits the maximum data payload to 1024-bytes for high-speed isochronous transfers, which makes it possible to transfer multiple MPEG-2 packets in just one USB isochronous packet, as is needed by the single Tx/Rx endpoint approach described above with respect to FIG. 4. MPEG encoding of video streams packages all video data into fixed-size 188-byte packets for transport. Therefore, theoretically, up to five MPEG-2 packets (188 bytes each) can be tunneled into a USB 2.0 micro-frame (with some room to spare). As noted in above, the term “tunneling” refers to the practice of putting one packet within another.

In FIG. 5, the top row (horizontal, across the figure) represents a sequence of USB 2.0 micro-frames (Fr). A first micro-frame Fr (n−2) 502 is followed by a second micro-frame Fr (n−1) 504, which is followed by a third micro-frame Fr (n) 506, which is followed by a fourth micro-frame Fr (n+1) 508, which is followed by a fifth micro-frame Fr (n+2) 510, etc. Each micro-frame has a duration of 125 μs, and a size of 7500 bytes.

The second row shown in FIG. 5 is a blowout (expansion, “magnified view”) of one of the micro-frames (Fr(n)) 506, showing the structure of a representative, single USB 2.0 isochronous data packet, which is a portion of the associated micro-frame 506. The USB packet comprises four sync bytes 512, followed by 985 bytes of payload 514 (the maximum payload is 1024 bytes), followed by two bytes of error checking (CRC, 16-bits) 516. The payload 514 comprises one byte of packet ID (PID) 518, followed by five packets (PKT1 . . . PKT5), 520a, 520b, 520c, 520d, 520e, each packet having 197-bytes. The packets 520a . . . 520e are modified MPEG-2 packets.

In FIG. 5, the third (bottom) row is a blowout of a representative one of the USB packets (PKT3) 520c in the payload portion 514 of the micro-frame 506. It can be seen that each USB packet contains an MPEG packet 534 (payload, 188 bytes) which has been modified. In particular, fields 522, 524, 526, 528, 530, 532 are added by the host (404) to each of the MPEG packets 534 when multiple MPEG-2 transport packets are multiplexed and transferred in a single isochronous (USB 2.0) packet:

Transport Stream ID (TSID) field 524. For two or more transport streams (TSs), it is advantageous to tag the MPEG packets with transport stream ID (TSID) fields so that they can be easily demultiplexed and uniquely identified as belonging to a particular service (i.e., particular TS) upon reaching their destination. This field is suitably eight bits in length.

Local Time Stamp (LTS) field 530. The packets need to be tagged with a local time stamp in order to conserve the MPEG timing of the packets. This field is suitably 32 bits in length.

Packet Count (PKTcnt) field 522. Since the data payload per isochronous transfer is limited to 1024 bytes, a maximum of five full MPEG packets can be transferred per isochronous packet. A high-speed high-bandwidth endpoint is allowed up to three isochronous transactions (isochronous USB 2.0 packets) per micro-frame, hence a maximum of fifteen MPEG packets can be transferred across the USB interface from Host to ACD (or ACD to host) in a single USB micro-frame. In the single endpoint approach, the MPEG packets are pre-buffered in a FIFO memory (1600 bits/TS) and after insertion of the various fields such as TSID and LTS, they will be stored in the host DRAM buffer (not shown) before being transferred to the ACD. The packets are marked with a Packet Count (PKTcnt) field 522, which is simply the order in which the packet is stored in the DRAM buffer. The packet count field 522 is used as a continuity counter to keep track of all the packets that get transferred in a micro-frame. When packets are sent across the interface in a given micro-frame (e.g., Fr(n)), some will arrive after processing from the ACD in a later micro-frame (Fr(n+1)), and the rest in a subsequent micro-frame (Fr(n+2)). The packet count field is used to determine if all the packets sent in a particular micro-frame have arrived back to the host (404) after processing. This field is suitably eight bits in length.

ACD Reserve Bits (ACDres) field 526. This is an optional field, suitably eight bits in length, and is reserved for use by the ACD (402). As noted above, this field can be more generically referred to as a CLIENTres field.

Host Reserve Bits (HOSTres) field 528. This is an optional field, suitably eight bits in length, and is reserved for use by the host (404).

CRC bits, (CRC) field 532. This is an optional field, suitably eight bits in length, and is used for cyclic redundancy check (CRC) bits to ensure that the host inserted fields (522, 524, 526, 528, 530) are transferred correctly across the interface (410).

The fields 522, 524, 526, 528, 532 can be inserted in any order, either in front of (ahead of, preceding) or in back of (following) the MPEG packet payload packet 534.

The size of the original MPEG packet is 188 bytes. The size of the modified MPEG packet is 197 bytes (188 bytes plus 72-bits/9-bytes for the fields described above).

(2) Multiple Tx/Rx Endpoints

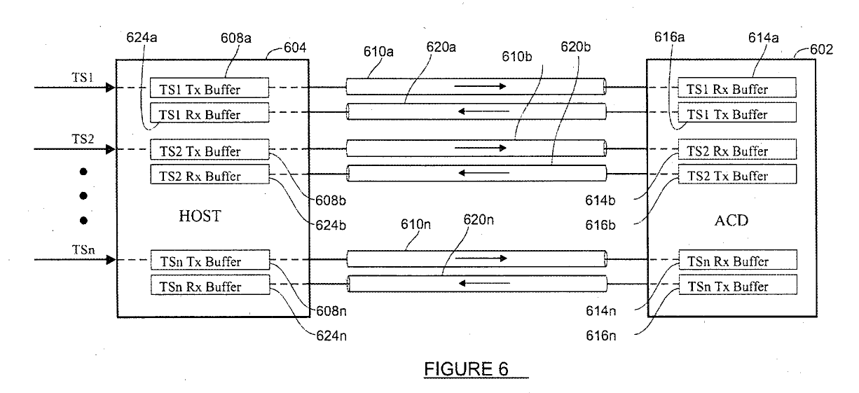

FIG. 6 is a diagram of a multiple endpoint approach to transferring data between an ACD and an STB, according to the invention. In this approach, multiple Tx/Rx Endpoints are used between the ACD 602 and the host set-top 604. There is one transmit and receive endpoint (pipe) per service (transport stream TS1, TS2 . . . TSn) to transfer data across the USB 2.0 interface, which translates into having multiple Tx/Rx endpoints between ACD and host. In this example, the transport streams (TSs) are encrypted, requiring decryption by the ACD.

A first transport stream TS1 is buffered in the host 604 by host Tx buffer 608a, transferred from the host 604 to the ACD 602 via pipe 610a, buffered at the ACD by ACD Rx buffer 614a, decrypted by the ACD 602, buffered in the ACD 602 by ACD Tx buffer 616a, transferred by the ACD 602 to the host 604 via pipe 620a, received by the host 604, and buffered in the host 604 by host Rx buffer 624a.

Likewise, a second transport stream TS2 is buffered in the host 604 by host Tx buffer 608b, transferred from the host 604 to the ACD 602 via pipe 610b, buffered at the ACD by ACD Rx buffer 614b, decrypted by the ACD 602, buffered in the ACD 602 by ACD Tx buffer 616b, transferred by the ACD 602 to the host 604 via pipe 620b, received by the host 604, and buffered in the host 604 by host Rx buffer 624b.

Likewise, an “n-th” transport stream TSn is buffered in the host 604 by host Tx buffer 608n, transferred from the host 604 to the ACD 602 via pipe 610n, buffered at the ACD by ACD Rx buffer 614n, decrypted by the ACD 602, buffered in the ACD 602 by ACD Tx buffer 616n, transferred by the ACD 602 to the host 604 via pipe 620n, received by the host 604, and buffered in the host 604 by host Rx buffer 624n.

This multiple Tx/Rx Endpoint technique (FIG. 6) does not require any special transport stream syntax (FIG. 5) as was required with the single transmit/receive (Tx/Rx) Endpoint technique (FIG. 4).

Overhead Comparison

Each USB high-speed isochronous endpoint can transfer up to 1024 bytes per micro-frame and has an overhead of 38 bytes excluding the overhead due to bit-stuffing. USB limits the number of isochronous transfers per endpoint per frame to a single transaction unless the endpoint is a high-speed, high-bandwidth endpoint. A high speed high bandwidth endpoint is allowed up to three isochronous transactions per micro-frame and therefore can move up to 3072 bytes of data per micro-frame.

In the multiple endpoint approach (FIG. 6), the overhead increases with number of endpoints; addition of a single point adds 38 bytes to the bus overhead. In the single endpoint approach (FIG. 4), since data from different services is multiplexed and sent in a single endpoint, overhead is dependent on the total size of payload to be transferred per frame. The table below summarizes the overhead due to high-speed, high bandwidth isochronous transfers for a single endpoint:

TABLE 1
Isochronous Transfer Overhead

| Payload Size/μ- | | |
|---|---|---|
| frame (P Bytes) | Isochronous Transfer | Overhead/Transfer/Endpoint |
| P ≦ 1024 | High Speed High BW | 38 Bytes |
| 1024 < P ≦ 2048 | High Speed High BW | 76 Bytes |
| 2048 < P ≦ 3072 | High Speed High BW | 114 Bytes |

In order to see how the addition of endpoints will significantly add to overhead, consider a possible use case where the ACD is interfaced to a multi-stream set-top gateway and needs to simultaneously decrypt six different standard definition (SD) services at six Mbps. To support this use-case using the multiple endpoint approach, one would need six IN endpoints (transmitting from the ACD to the Host) and six OUT endpoints (transmitting from the Host to the ACD.) The total overhead/micro-frame in this case would be:

OH=38 Bytes*(Total # of endpoints)=38*12=456 Bytes/micro-frame

If the single endpoint method were used to support this case, the total overhead/micro-frame would be:

$$\begin{matrix}OH = \sum 38 \times ( [ \frac{M}{1024} ] + [ \frac{N}{1024} ] ) \\ ⇒ OH = 38 \times 2 = 76 Bytes\end{matrix}$$

where,

$$\begin{matrix}M = Total number of bytes to be \\ transferred \text{/} micro \text{-} frame from ACD to Host \\ = [ 6 \times 6 Mbps \times 125 us / 8 ] \\ = 563 Bytes \\ N = Total number of bytes to be \\ transferred \text{/} micro \text{-} frame from Host to ACD \\ = [ 6 \times 6 Mbps \times 125 us / 8 ] \\ = 563 Bytes\end{matrix}$$

(Note that M, N=3072)

[ ]=Greatest Integer Function.

Hence, for this particular use-case, the single endpoint approach is six times more efficient (76 bytes vs. 456 bytes) than the multiple endpoint approach for transferring the same size data payload. Also, the ratio R={Payload bytes/Overhead Bytes} is 24.68 for the single endpoint approach (therefore, one overhead byte is added every ˜25 payload bytes). This ratio is much less for the multiple endpoint approach, where R=4.11. Hence, one overhead byte is added every four payload bytes if transfers are made using the multiple endpoint approach. This makes the multiple endpoint approach very inefficient.

The table below is a comparison of overhead per micro-frame on the bus using the single endpoint and multiple endpoint approaches for some ACD use-cases:

TABLE 2
Isochronous Transfer Overhead

| | MEP OH | SEP OH | Delta |
|---|---|---|---|
| Use Case | (Bytes) | (Bytes) | (Bytes) |
| Single Tuner HD/SD | 152 | 76 | 76 |
| Dual Tuner HD/SD | 228 | 76 | 152 |
| Single Tuner HD, PVR | 266 | 114 | 152 |
| Dual Tuner HD/SD, dual PVR | 456 | 190 | 366 |
| Six Tuner SD Gateway | 532 | 76 | 456 |

MEP = Multiple Endpoint Approach
SEP = Single Endpoint Approach
OH = Overhead

Hence, the single endpoint approach offers more efficient bandwidth usage than the multiple endpoint approach for transferring same size data payloads by significantly reducing protocol overhead.

Although the invention has been described in connection with various specific embodiments, those skilled in the art will appreciate that numerous adaptations and modifications may be made thereto without departing from the spirit and scope of the invention as set forth in the claims.

What is claimed is:

1. A method for transferring selected packets from multiple different MPEG transport streams between a host and an endpoint device over a high speed serial communications interface, comprising:
tunneling the selected MPEG transport packets into high speed frames; and
transporting the high speed frames over a single high speed pipe.

2. A method according to claim 1, wherein:
each high speed frame comprises five MPEG transport packets.

3. A method according to claim 1, wherein:
the MPEG transport packets are modified by additional fields prior to transporting over the pipe.

4. A method according to claim 1, wherein:
the host has one transmit (Tx) pipe and one receive (Rx) pipe; and
the endpoint device has one receive (Rx) pipe and one transmit (Tx) pipe.

5. A method according to claim 1, wherein:
the host has multiple transmit (Tx) pipes and multiple receive (Rx) pipes; and
the endpoint device has multiple receive (Rx) pipes and multiple transmit (Tx) pipes.

6. A method according to claim 1, wherein:
the host is a set top box (STB); and
the endpoint device is an access control device (ACD).

7. A method according to claim 1, wherein selected ones of the multiple MPEG transport streams are encrypted, and further comprising:
decrypting the encrypted MPEG transport streams at the endpoint device; and
transferring the decrypted MPEG transport streams back to the host.

8. A method according to claim 1 wherein said high speed frames comprise USB micro-frames.

9. A method for sending multiple MPEG transport streams over an interface between a host and an endpoint device, comprising modifying a plurality of MPEG transport packets for transfer over the interface by:
(i) uniquely identifying each of the MPEG transport packets with a transport stream ID (TSID) field as belonging to a particular one of the multiple transport streams;
(ii) tagging the MPEG transport packets with a local time stamp (LTS) field; and
(iii) marking the MPEG transport packets with a packet count (PKTcnt) field for indicating the order in which the packet is stored by the host in a buffer, and for use as a continuity counter to keep track of the packets that get transferred.

10. A method according to claim 9, wherein:
the transport stream ID field comprises 8 bits;
the local time stamp field comprises 32 bits; and
the packet count field comprises 8 bits.

11. A method according to claim 9, comprising:
following the packet count field by the transport stream ID field; and
following the transport stream ID field by the local time stamp field.

12. A method according to claim 9, comprising:
inserting each of the packet count field, the transport stream ID field, and the local time stamp field ahead of a payload which is the original MPEG transport packet.

13. A method according to claim 9, further comprising:
reserving a client reserve bits (CLIENTres) field for use by the endpoint device;
reserving a host reserve bits (HOSTres) field for use by the host; and
using a CRC bits field for ensuring that the fields which are added to the MPEG transport packets are transferred correctly across the interface.

14. A method according to claim 13, wherein:
the client reserve bits field comprises 8 bits;
the host reserve bits field comprises 8 bits; and
the CRC bits field comprises 8 bits.

15. A method according to claim 13, comprising:
following the packet count field by the transport stream ID field;
following the transport stream ID field by the CLIENT reserve bits field;
following the CLIENT reserve bits field by the host reserve bits field;
following the host reserve bits field by the local time stamp field; and
following the local time stamp field by the CRC bits field.

16. A method according to claim 13, comprising:
inserting each of the packet count field, the transport stream ID field, the CLIENT reserve bits field, the host reserve bits field, the local time stamp field, and the CRC bits field ahead of the payload.

17. A method according to claim 13, wherein the endpoint device is an ACD, and the CLIENTres field is an ACDres field.

18. A method for transporting a plurality of MPEG streams selected from different multiplexes (TS₁, TS₂ . . . TS_{N}) between a host and an endpoint device for processing, and transporting the resulting processed transport streams (TS′₁, TS′₂ . . . TS′_{N}) back to the host, comprising:
at the host, receiving a plurality of MPEG transport streams; and
providing the MPEG transport streams to a client module for processing, over a high speed serial communications interface.

19. A method according to claim 18, wherein:
the high speed serial communications interface conforms to one of the USB 2.0 or IEEE 1394 standard.

20. A method according to claim 18, further comprising:
at the host, multiplexing the plurality of transport streams into a first multiplexed stream and transporting the first multiplexed stream to the endpoint device for processing; and
at the endpoint device, demultiplexing the first multiplexed stream, processing the demultiplexed plurality of transport streams, multiplexing the demultiplexed, processed plurality of transport streams into a second multiplexed stream, and transporting the second multiplexed stream to the host.

21. A method according to claim 20, wherein:
a single USB Tx/Rx endpoint is used to transfer the multiple MPEG streams.

22. A method according to claim 21, wherein:
transport packets of the MPEG transport streams are grouped and sent in a single isochronous packet.

23. A method according to claim 22, wherein:
multi-byte fields are added to the MPEG transport packets.

24. A method according to claim 18, comprising:
using multiple USB Tx/Rx endpoints to transfer the multiple MPEG streams.

25. A method according to claim 18, wherein said host comprises a set top box (STB).

26. A method according to claim 18, wherein said streams are encrypted, and the processing at the endpoint device comprises decrypting the streams.

27. Apparatus for transporting multiple MPEG transport streams over an interface between a host and an endpoint device, comprising:
a processor adapted to modify a plurality of MPEG transport packets for transfer over the interface;
said processor adding the following fields to each of the MPEG transport packets:
(i) a transport stream ID (TSID) field for uniquely identifying each of the MPEG transport packets as belonging to a particular one of the multiple transport streams;
(ii) a local time stamp (LTS) field for tagging the MPEG transport packets with a local time stamp; and
(iii) a packet count (PKTcnt) field for marking the MPEG transport packets with a indication of the order in which the packet is stored in by the host in a buffer, and for use as a continuity counter to keep track of all the packets that get transferred.

28. Apparatus according to claim 27, wherein:
the multiple MPEG transport streams are encrypted,
the host is a set top box (STB); and
the endpoint device is a security/decryption module.

29. Apparatus according to claim 27, wherein said host comprises said processor.

30. A method for transferring selected packets from different transport streams between a host and a client, comprising:
appending a transport stream identifier (TSID) to each selected packet;
tunneling the selected packets with the appended TSIDs into a combined stream; and
transporting the combined stream over a single high speed pipe.

31. A method in accordance with claim 30, wherein:
said combined stream is transported from the host to the client over said pipe; and
said client recovers the selected packets from the transport stream for processing.

32. A method in accordance with claim 31, wherein the selected packets are transported back to said host after processing.

33. A method in accordance with claim 30, wherein said pipe is an isochronous pipe.

34. A method in accordance with claim 30, wherein the selected packets are tagged with timing information prior to said transporting step.

35. A method in accordance with claim 34, wherein:
said combined stream is transported from the host to the client over said pipe;
said client recovers the selected packets from the transport stream for processing;
the selected packets, with the appended timing information, are transported back to said host from the client after processing; and
the host recovers the timing information from the packets received from the client.

36. A method in accordance with claim 35, wherein:
the selected packets are also tagged with packet count information prior to said transporting step; and
the host recovers the packet count information from the packets received from the client.

37. A method in accordance with claim 36, wherein said packets are MPEG packets.
